(19) United States
(12) Patent Application Publication
(10) Pub. No.: US 2014/0181215 A1
(43) Pub. Date: Jun. 26, 2014

(54) Method, System and Computer Program Product for Messaging Over a Network

(71) Applicant: Chukwunonso Omoko, Port Hartcourt (NG)

(72) Inventor: Chukwunonso Omoko, Port Hartcourt (NG)

(21) Appl. No.: 12/684,857

(22) Filed: Jan. 8, 2010

Related U.S. Application Data
(60) Provisional application No. 61/144,163, filed on Jan. 13, 2009.

(51) Int. Cl. H04L 12/58

(52) U.S. Cl. CPC H04L 51/22
USPC 709/206

(57) ABSTRACT

A method, system and computer program product for messaging over a network includes steps and means for logging on to engage in a messaging conversation with at least one party over a communication network. Steps and means prepare messages for the at least one party using a plurality of text input boxes. Steps and means select a one of the plurality of text input boxes for sending to the at least one party a contained message within the one of the plurality of text input boxes. Other embodiments further include steps and means for sending at least a portion of the contained message separately from the contained message and steps and means for adding an additional text input box to the plurality of text input boxes.

### CROSS-REFERENCE TO RELATED APPLICATIONS

The present Utility patent application claims priority benefit of the U.S. provisional application for patent Ser. No. 61/144,163 filed on Jan. 13, 2009 under 35 U.S.C. 119(e). The contents of this related provisional application are incorporated herein by reference for all purposes.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

The present invention relates generally to instant messengers. More particularly, the invention relates to an instant messenger client that enables multiple messages to be entered at one time and send at different times to the same recepient.

### BACKGROUND OF THE INVENTION

Instant messengers (IMs) are used to hold discussions between two users in a chat session or multiple users in a chat room. In a chat session, instant messenger clients have two basic components; a single message output area, also called the message display area and a single text input box. The content of the message output area is visible to all parties in the chat session. A user types message into text input box and the message is sent to the message output area once the user triggers a send command (e.g., by clicking a send button).

However, due to the fact that no two users in a chat session can have exactly the same typing speed, situations often arise where one party types and sends questions or comments faster than the other party can respond, thereby changing the context of the discussion before the slower party is able to respond to the last question. This typically results in a situation where the slower party ends up aborting and deleting a response he is currently typing so as to respond to the most recent questions. Unfortunately, the slower party then must retype the aborted response if he still wishes to respond to the earlier question. This limitation is due to the fact that present instant messenger configurations only have a single text input box, thus, only one unsent message can be held at a time.

Likewise, the faster party may remain idle while waiting for the slower party to respond. At such time, the faster party may lose his train of thought as he has no means to type or jot down his next planned questions. He is not able to type his next planned messages due to the fact that present instant messenger configurations only have a single text input box, thus only one unsent message can be typed or held by the instant messenger client at one time. He is therefore forced to wait for the response to determine the message he wishes to type next.

In view of the foregoing, there is a need for improved techniques for enabling users of instant messenger clients to enter multiple messages at one time and send them at different times in a preffered sequence to the same receipient.

### BRIEF DESCRIPTION OF THE DRAWINGS

The present invention is illustrated by way of example, and not by way of limitation, in the figures of the accompanying drawings and in which like reference numerals refer to similar elements and in which:

FIGS. 1A through 1D illustrate an exemplary send sequence control enabled instant messenger client, in accordance with an embodiment of the present invention. FIG. 1A shows the client in a single or multiple frame mode in its initial state once launched. FIG. 1B shows the exemplary client in a tab mode. FIG. 1C shows the client in the single frame mode after a new text box (NTB) button is clicked once, and FIG. 1D shows the client in the multiple frame mode after the NTB button is clicked once;

FIG. 2 is a flow chart illustrating an exemplary process for using an instant messenger client with send sequence control in single frame mode during a chat session between two users, in accordance with an embodiment of the present invention;

FIG. 3 shows an exemplary step-by-step demonstration of how an exemplary instant messenger client with send sequence control is used in a single frame mode during a chat session between two users, in accordance with an embodiment of the present invention;

FIG. 4 shows an exemplary step-by-step demonstration of how an exemplary instant messenger client with send sequence control is used in a tab mode during a chat session between two users, in accordance with an embodiment of the present invention;

FIG. 5 shows an exemplary step-by-step demonstration of how an exemplary instant messenger client with send sequence control is used in a highlighted mode during a chat session between two users, in accordance with an embodiment of the present invention; and

FIG. 6 illustrates a typical computer system that, when appropriately configured or designed, can serve as a computer system in which the invention may be embodied.

Unless otherwise indicated illustrations in the figures are not necessarily drawn to scale.

### SUMMARY OF THE INVENTION

To achieve the forgoing and other objects and in accordance with the purpose of the invention, a method, system and computer program product for messaging over a network is presented.

In one embodiment a method includes steps for engaging in a messaging conversation over a communication network, steps for preparing messages using a plurality of text input boxes and steps for selecting a text input box for sending a contained message. Another embodiment further includes steps for sending at least a portion of the contained message separately from the contained message. Yet another embodiment further includes steps for adding an additional text input box. Still another embodiment further includes steps for canceling a text input box.

In another embodiment a method includes the steps of engaging in a messaging conversation with at least one party over a communication network. A step prepares messages for the at least one party using a plurality of text input boxes. A step selects a one of the plurality of text input boxes for sending to the at least one party a contained message within the one of the plurality of text input boxes. Another embodiment further includes the step of highlighting at least a portion of the contained message for sending the highlighted portion separately from the contained message. Yet another embodiment further includes the step of adding an additional text input box to the plurality of text input boxes. Still another embodiment further includes the step of canceling a text input box wherein the contained message is deleted. In another embodiment the text input box is removed from view. In yet another embodiment each of the plurality of text input boxes is tabbed for selecting for input and for sending. In still another embodiment the text input boxes are contained in a plurality of frames.

In another embodiment a system includes means for logging on to engage in a messaging conversation with at least one party over a communication network, means for preparing messages for the at least one party using a plurality of text input boxes and means for selecting a one of the plurality of text input boxes for sending to the at least one party a contained message within the one of the plurality of text input boxes. Another embodiment further includes means for sending at least a portion of the contained message separately from the contained message. Yet another embodiment further includes means for adding an additional text input box. Still another embodiment further includes means for canceling a text input box.

In another embodiment a computer program product residing on or being distributed across one or more computer readable mediums having a plurality of instructions stored thereon which, when executed by one or more associated processors, cause the one or more processors to enable a user to engage in a messaging conversation with at least one party over a communication network, enable a user to prepare messages for the at least one party using a plurality of text input boxes and enable a user to select a one of the plurality of text input boxes for sending to the at least one party a contained message within the one of the plurality of text input boxes. Another embodiment further includes instructions to enable a user to highlight at least a portion of the contained message for sending the highlighted portion separately from the contained message. Yet another embodiment further includes instructions to enable a user to add an additional text input box to the plurality of text input boxes. Still another embodiment further includes instructions to enable a user to cancel a text input box wherein the contained message is deleted. In another embodiment the text input box is removed from view. In yet another embodiment each of the plurality of text input boxes is tabbed for selecting for input and for sending. In still another embodiment the text input boxes are contained in a plurality of frames.

Other features, advantages, and object of the present invention will become more apparent and be more readily understood from the following detailed description, which should be read in conjunction with the accompanying drawings.

### DETAILED DESCRIPTION OF THE PREFERRED EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

The present invention will now be described in detail with reference to embodiments thereof as illustrated in the accompanying drawings.

Detailed descriptions of the preferred embodiments are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

It is to be understood that any exact measurements/dimensions or particular construction materials indicated herein are solely provided as examples of suitable configurations and are not intended to be limiting in any way. Depending on the needs of the particular application, those skilled in the art will readily recognize, in light of the following teachings, a multiplicity of suitable alternative implementation details.

Preferred embodiments of the present invention provide a feature in instant messengers that enables users to type multiple messages into their instant messenger client at once and choose the order by which to send these messages to the receiving party in a chat session. In preferred embodiments, this feature is called send sequence control for instant messengers. However, features providing the same functionality in alternate embodiments may be referred to by any number of different names. In preferred embodiments the user can alter the sequence in which they send their typed messages in the chat session in response to the changing context of the discussion. This is achieved by providing multiple text input boxes into which users can type different messages that may be sent in any sequence, thus generally ensuring that the sent message is in line with the flow of discussion and relevant to the current context of the discussion and avoiding the need to retype a suspended typed message if it is considered necessary to be sent later in the course of the discussion. The send sequence control for instant messengers feature in preferred embodiments solves the problem of not being able to input multiple messages in instant messenger clients by providing the following elements: multiple text input boxes from which messages can be sent to the single output area for a chat session, multiple tabs containing text input boxes, buttons or triggers which create additional text input boxes and accompanying control buttons, and send buttons or triggers that control each text input box with which a user can choose which message to send. Preferred embodiments of the present invention can be used on computers, television chat, mobile phones, hand held chat devices, hand held computers and organizers, or any other device that can be used for communication.

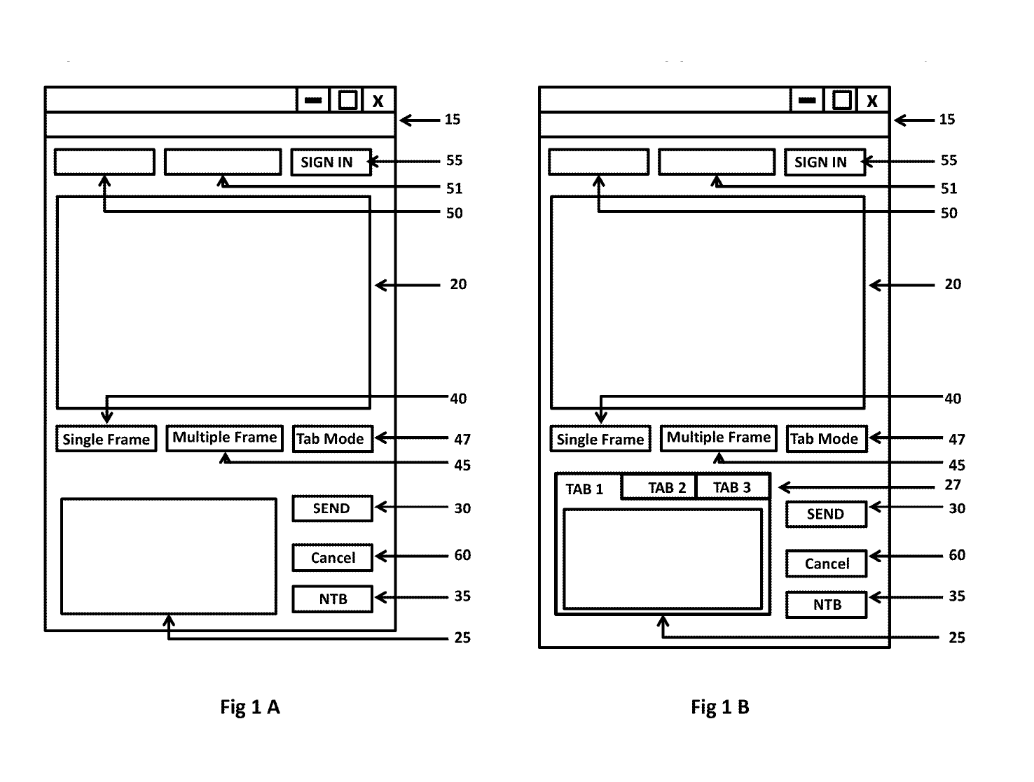

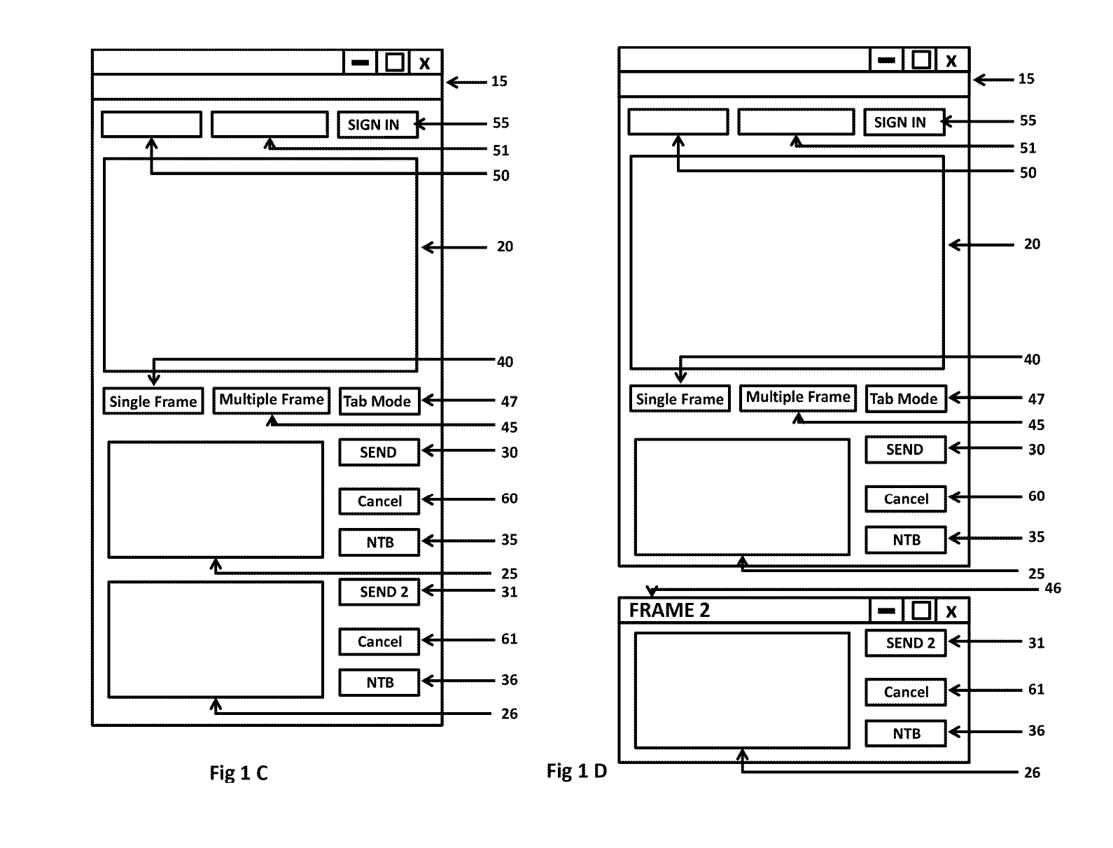

A basic embodiment of the present invention comprises an instant messenger client with more than one text input box from which messages can be sent to the same receiving party or parties in an instant messaging chat session. Each text input box has its own associated control buttons such as, but not limited to, send buttons and cancel buttons. The send button associated with each text input box makes the message typed into the text input box immediately appear in the message display area of all parties involved in the chat session. The extra text input boxes included in this embodiment may be individually visible, as shown by way of example, in FIGS. 1C and 1D, or may appear under tabs, as shown by way of example in FIG. 1B. The present embodiment also comprises a button or buttons in the instant messenger client that, when clicked, create extra text input boxes along with their associated control buttons, as shown by way of example in FIGS. 1A-1D. This button is herein referred to as a new text input box button (NTB button) in this disclosure. The present embodiment may be implemented with different configurations. For example, without limitation, the instant messenger client may launch with extra text input boxes being displayed immediately, as shown by way of example in FIGS. 1C and 1D. In another configuration, the instant messenger client may start up displaying a single message display area and a single text input box having an NTB button, as shown by way of example in FIG. 1A. In this configuration, the first extra text input box appears after the NTB button is clicked for the first time. Some embodiments may comprise labels for the various components that may be made to change and reflect the currently activated tab or frame. Configuration screens and menus may be provided in some embodiments to enable a user to set his preferences.

FIGS. 1A through 1D illustrate an exemplary send sequence control enabled instant messenger client, in accordance with an embodiment of the present invention. FIG. 1A shows the client in a single or multiple frame mode in its initial state once launched. FIG. 1B shows the client in a tab mode. FIG. 1C shows the client in the single frame mode after a new text box (NTB) button 35 is clicked once, and FIG. 1D shows the client in the multiple frame mode after NTB button 35 is clicked once. In the present embodiment, the instant messenger client comprises a menu/tool bar 15, a message output area 20, a text input box 25, a send button 30, NTB button 35, a single frame mode button 40, a multiple frame mode button 45, a tab mode button 47, a password box 50, a user ID box 51, a sign in button 55, and a cancel button 60. Menu/tool bar 15 gives a user access to any menus and tools available in the instant messenger client such as, but not limited to, Contact list, Add contact, Find friends, Files transfer, Configuration screen, etc. Messages are typed into text input box 25 by the instant messenger client user. Message output area 20, also called the message display area, displays all sent messages between the parties in a chat session. A message typed in text input box 25 appears here once send button 30 is clicked. When clicked, send button 30 sends the typed message in text input box 25 across to the receiving party or parties. In order to sign into the instant messenger client, the user enters a password into password box 50, and enters their user ID into user ID box 51. The user then clicks sign in button 55 to authenticate the contents of user ID box 51 and password box 50. Cancel button 60 may clear the screen of its associated components such as, but not limited to, text input box 25, send button 30, NTB button 35, and itself. Depending on a user's preference, clicking cancel button 60 may instead only clear the contents of text input box 25, which it controls.

Referring to FIGS. 1C and 1D, when clicked, NTB button 35 creates a new text box 26 along with its associated control buttons such as, but not limited to, a new send button 31, a new cancel button 61 and a new NTB button 36. New text input box 26 appears when NTB button 35 is clicked into which messages may be typed. New send button 31 sends the typed message in the associated new text input box 26 across to the receiving party or parties. New NTB button 36 creates another new text input box along with its associated control buttons such as, but not limited to, a send button, a cancel button and another new NTB button. The user may create as many new text input boxes as he wishes by clicking on the NTB buttons. Cancel button 61 may clear the screen of its associated components such as, but not limited to, new text input box 26, new send button 31, new NTB button 36, and itself or may clear the contents of new text input box 26.

To move between the modes of the instant messenger client, the user clicks the mode buttons. Single frame mode button 40 enables the instant messenger client to operate in the single frame mode, shown by way of example in FIGS. 1A and 1C. In this mode the new components created by clicking NTB button 35 or new NTB button 36 are contained within the original frame of the instant messenger client. In other words, the instant messenger client simply extends or expands to reveal the new components, as shown by way of example in FIG. 1C. Multiple frame mode button 45 enables the instant messenger client to operate in the multiple frame mode, shown by way of example in FIGS. 1A and 1D. In this mode the new components created by clicking NTB button 35 or new NTB button 36 are contained within a new frame 46, as shown by way of example in FIG. 1D. New frame 46 comprises new text input box 26 with associated new send button 31, new cancel button 61 and new NTB button 36. New frame 46 may also comprise other tools and menus such as, but not limited to, Contact list, Add contact, Find friends, Files transfer, Configuration screen, etc. Each time an NTB button is pressed in this mode a separate new frame is created. A Tab mode button 47 enables the instant messenger client to operate in the tab mode, shown by way of example in FIG. 1B. In this mode, text input box 25 is contained within a tab, and numerous tabs, each with text input boxes, are available. When in the tab mode, text input box tabs 27 are displayed. Messages to be sent to the receiving party are typed into the text input box contained within a tab. The contents of any activated tab are controlled by the control buttons available. Depending on the user's preference, clicking NTB button 35 in this mode can either create new tabs or create a new text input box 26 along with associated control buttons as earlier defined.

Those skilled in the art, in light of the present teachings, will readily recognize that instant messenger clients in alternate embodiments may be implemented with various different tools and menus such as, but not limited to, Contact list, Add contact, Find friends, Files transfer, Configuration screen, etc. Furthermore, the instant messenger clients in alternate embodiments may be organized in different formats, and may display items differently. For example, without limitation, in some embodiments the password and user ID boxes and sign in button may disappear once the user is successfully logged into the instant messenger client. The buttons may be arranged in any order or combinations. Also, the components of the instant messenger client may be rearranged in different positions other than the positions shown. The buttons and other components may be associated with the text input box that they control by means of labeling, color, proximity, shape or any other indicator. In some embodiments the instant messenger client may be configured to display multiple text input boxes as a default upon launching.

In typical use of the present embodiment, a user types a message into text input box 25 of the instant messenger client. If the user then decides not to send this message across to the other participant(s) of the chat, the user may click NTB button 35 to automatically create a new text input box 26 into which he can type his preferred message. This action also creates the accompanying buttons with which to control new text input box 26, including, but not limited to, new NTB button 36, new send button 31 and new cancel button 61. The user can create as many new text input boxes as he desires, and each accompanying button is labeled to facilitate identification and association with the new text input box. With the possible existence of multiple text input boxes (TIBs) and accompanying control buttons, it may become difficult for the user to distinguish which buttons control which TIBs. This confusion is reduced by ensuring that the buttons are physically associated to the TIBs they control, this could be done, for example, but not limited to, by labeling, such as Send Button 1 implies a control for TIB 1, proximity to the TIB, association by color, etc. Depending on whether the user is in the single frame mode or the multiple frame mode, the new texts boxes either will be contained within the same original frame of the instant messenger client or will come up as a new frame. When ready, the user can then send the contents of each text input box in any order or sequence by clicking the associated send button. The send action performed when new send button 31 is clicked may or may not close new text input box 26, depending on the user's preferred settings. Since, the instant messenger client may be configured to retain multiple text input boxes and their control buttons after their associated send button has been clicked. This will make the additional text input boxes available for quick and easy access.

Referring to FIG. 1B, if the client is operating in the tab mode, the user clicks a new text input box tab 27 to be presented with a new text input box within the new tab into which a new message can be typed and sent to the receiving party. The contents of any activated tab are controlled by the control buttons available, such as, but not limited to, the visible NTB button 35, send button 30 and cancel button 60. By default, the user has access to a fixed number of tabs in the tab mode. However, depending on the user's preference, clicking NTB button 35 will either create new tabs or create a new text input box along with associated control buttons as earlier defined. In the present embodiment, all of the tabs share the same set of control buttons; however, in alternate embodiments, each tab may comprise its own separate set of control buttons.

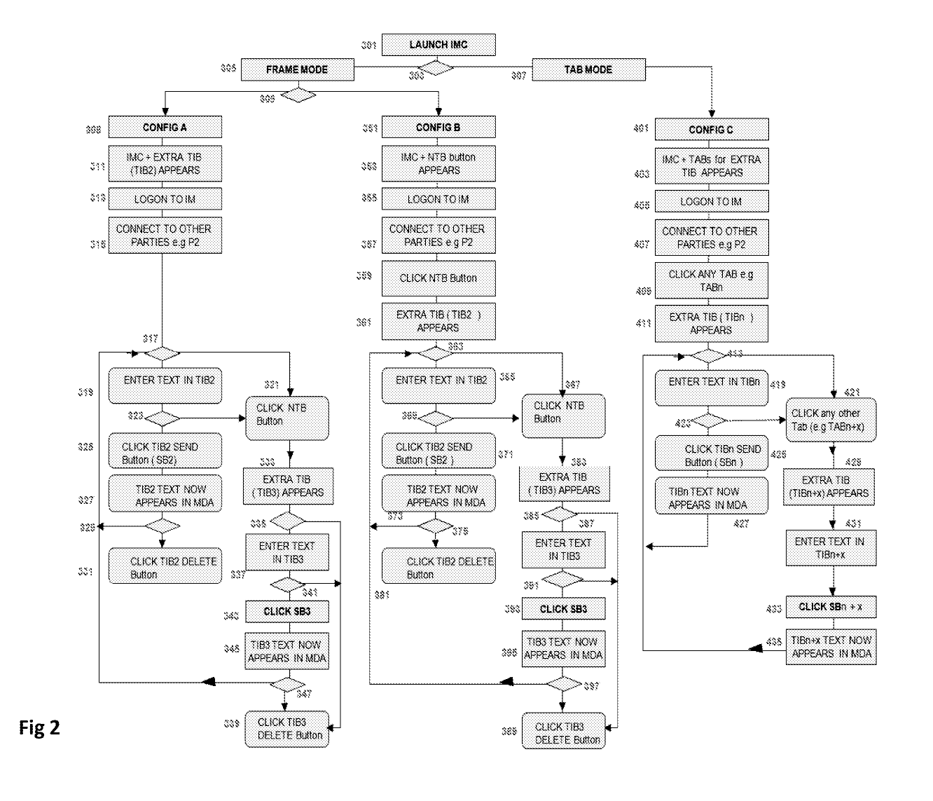

FIG. 2 is a flow chart illustrating an exemplary process for using an instant messenger client with send sequence control in single frame mode during a chat session between two users, in accordance with an embodiment of the present invention. In the present embodiment, the process begins at step 301 where a user launches the instant messenger client (IMC). In step 303 the user determines which configuration he would like to use. The present embodiment comprises a frame mode and a tab mode; however, alternate embodiments may comprise various other configurations such as, but not limited to, a user defined combination of Frame and Tab mode features, a flexible mode that allows a user to switch between Frame and Tab modes during use, etc. Based on the user's chosen configuration options, the instant messenger client either opens in the frame mode in step 305 or in the tab mode in step 307. The frame mode entered in step 305 can be further opened in the present embodiment as configuration A or configuration B; however, alternate embodiments may make various other configurations available in the frame mode. In the present embodiment the user chooses between configuration A and configuration B in step 307. In configuration A, entered in step 309, the instant messenger client opens showing a typical instant messenger client in addition to an extra text input box (TIB2) or multiple extra text input boxes in step 311. A typical instant messenger client consist mainly of a single message output area, a single text input box (TIB1) and control buttons. In step 313 the user logs onto the instant messenger. In step 315, the user connects to another party to communicate with the other party (P2). In step 317 the user can decide to type a message into the available text input boxes in step 319 or to click the NTB button to open another text input box in step 321. In step 323, the user decides if he wishes to send the message typed in one of the available text input boxes. If the user is not ready to send the already typed messages, he can click the NTB button once more in step 321 to open another text input box (TIB3). If however, the user decides in step 323 to send any of the already typed messages, he clicks the send button associated with that text input box (e.g., SB2 for TIB2) in step 327. Once the send button is clicked, the typed message in this text input box is sent across to the other party and appears in the message output area in step 331. At this point, the user may return to step 317 to decide whether to enter new text into the same text input box in step 319 or to click the NTB button in step 321, or the user may proceed to step 331 to click the delete button associated with this text input box. In FIGS. 1A-1D this delete button is labeled as Cancel. One of ordinary skill in the art will readily recognize that the delete button may have various other names in other embodiments. If the delete button is clicked in step 331, the associated text input box, along with its associated control buttons, including, but not limited to the delete button and the send button, disappears. If the option of clicking the NTB button in step 321 is chosen, an extra text input box, (TIB3), appears in step 333 once the NTB button is clicked. At this point in step 335, the user decides to enter new text in the new text input box in step 337 or decides to abort the thread of text by clicking the delete button to delete the text input box in step 339. If the user opts to enter text into the text input box in step 337, the process continues to step 341 where the user can still decide to abort this thread of text in step 339 by clicking the delete button or can proceed to send the text in step 343 by clicking the send button associated with the text input box (SB3). Once the send button is clicked, the typed message in this text input box is sent across to the other party and appears in the message output area in step 345. In step 347, the user returns to step 317 where he may decide to simply enter new text into the same text input box in step 323 or click the NTB button in step 321 or click the delete button associated with this text input box in step 339. If the delete button is clicked in step 339, the associated text input box, along with its associated control buttons, including, but not limited to, the delete button and the send button, disappears.

If the user chooses configuration B in step 307, the instant messenger client opens in configuration B in step 351 showing a typical instant messenger client in addition to an NTB button in step 353. A typical instant messenger client comprises a single message output area, a single text input box and control buttons. The user then logs onto the instant messenger in step 355. In step 357 the user connects to another party to communicate with this party (P2). The user can now type text into the available text input box as usual in conventional use of the instant messenger client. However, if the user decides to type an alternate message so as to later choose which message to send first, he clicks the NTB button in step 357. An extra text input box (TIB2) then appears along with its associated control buttons in step 361. In step 363 the user decides whether to type a new message into the new text input box in step 365 or click the NTB button once more to open another text input box (TIB3) in step 367. If the user types a message into the second text input box (TIB2) in step 365, he may then decide in step 369 to send this message by clicking the send button (SB2) associated with that text input box. Once the send button is clicked, the typed message in the text input box is sent across to the other party and appears in the message output area in step 373. At this point, step 375, the user may return to step 363 where he may decide to go to step 365 and simply enter new text into the same text input box or go to step 367 to open a new text input box or the user may go to step 381 by clicking the delete button associated with this text input box. If the delete button is clicked, the associated text input box, along with its associated control buttons, disappears. If the user returns to step 367, an extra text input box (TIB3) appears once the NTB button is clicked. At this point in step 385, the user may proceed to step 387 to enter text into the new text input box or may decide to abort the thread of text by proceeding to step 389 and clicking the delete button. If the user decides to type text into the text input box (TIB3) in step 387, he proceeds to step 391 where the user can still decide to abort this thread of text by clicking the delete button in step 389, or he may proceed to send the message in step 393 by clicking the send button associated with this text input box (SB3). Once the send button is clicked, the typed message in this text input box is sent across to the other party and appears in the message output area in step 395. At this point, the user has the option in step 397 to return to step 363 to decide enter new text into the same text input box in step 365 or open a new text input box by clicking the NTB button in step 367, or the user may click the delete button associated with this text input box in step 389 to delete the text input box and its associated control buttons.

If in step 303 the user chooses the tab mode, the instant messenger client opens as configuration C in step 401 in the present embodiment; however, other possible configurations may be available in the tab mode in alternate embodiments. In configuration C, the instant messenger client opens in step 403 as shown by way of example in FIG. 1B with multiple text input boxes held under the displayed tabs and a default text input box showing (TIB1). The user then logs onto the instant messenger in step 405. In step 407, the user connects to the other party to communicate with this party (P2). The user can type text into the showing text input box (TIB1) as usual in conventional use of an instant messenger; however, if the user decides to type an alternate message so as to later choose which message to send first, he may clicks any of the other tabs (Tabn) to reveal a different text input box (TIBn) in step 409. The new text input box appears along with its associated control buttons in step 411. In step 413 the user can decide to go to step 419 to type a message into the new text input box, or the user may click on another tab to reveal another text input box. In step 423 the user decides if he is ready to send any of the messages that he already has typed in the previously opened text input boxes. If the user is still not ready to send any of the already typed messages, he can click any other tab to reveal another text input box in step 421. If however, he decides to send any of the already typed messages, the user clicks the send button associated with that text input box (SBn) in step 425. Once the send button is clicked, the typed message in this text input box is sent across to the other party and appears in the message output area in step 427. At this point, the user returns to step 413 where he may simply enter new text into the same text input box in step 419 or click another tab to reveal a new text input box in step 421. If the user chooses a new tab, an extra text input box appears in step 429, for example, without limitation, clicking Tab3 reveals TIB3. The user can now type text into the new text input box (TIBn+x) in step 431. The user then clicks the send button associated with this text input box (SBn+x) in step 433. Once the send button is clicked, the typed message in this text input box is sent across to the other party and appears in the message output area in step 435. The user then returns to step 413.

Those skilled in the art, in light of the present teachings, will readily recognize that the foregoing process is described for illustrative purposes and that many of the steps outlined may be performed in various different sequences in alternate embodiments. Furthermore some of the steps described may be omitted or additional steps may be included in alternate embodiments. For example, without limitation, Steps 305, 303, 307, 308, 351, 401, 329, 331, 347, 339, 375, 381, 397 and 389 may be skipped as optional. Also, the foregoing process was described in reference to a two person chat. However, this process may be performed for a chat session involving more than two people, for example, without limitation, in a chat room environment.

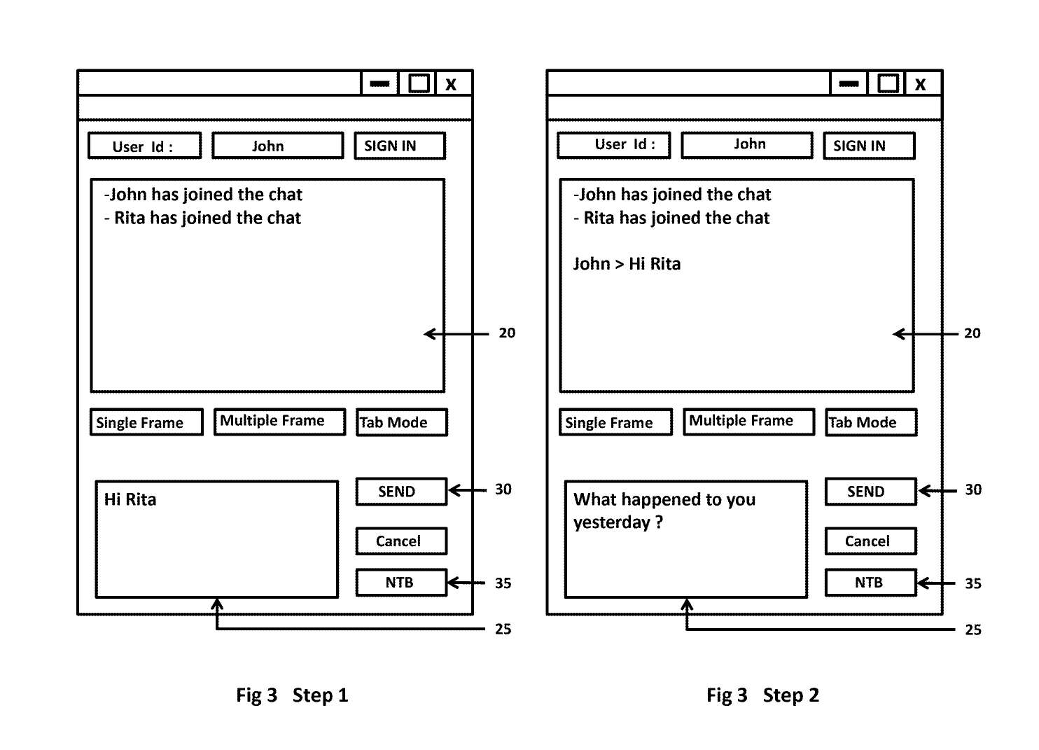

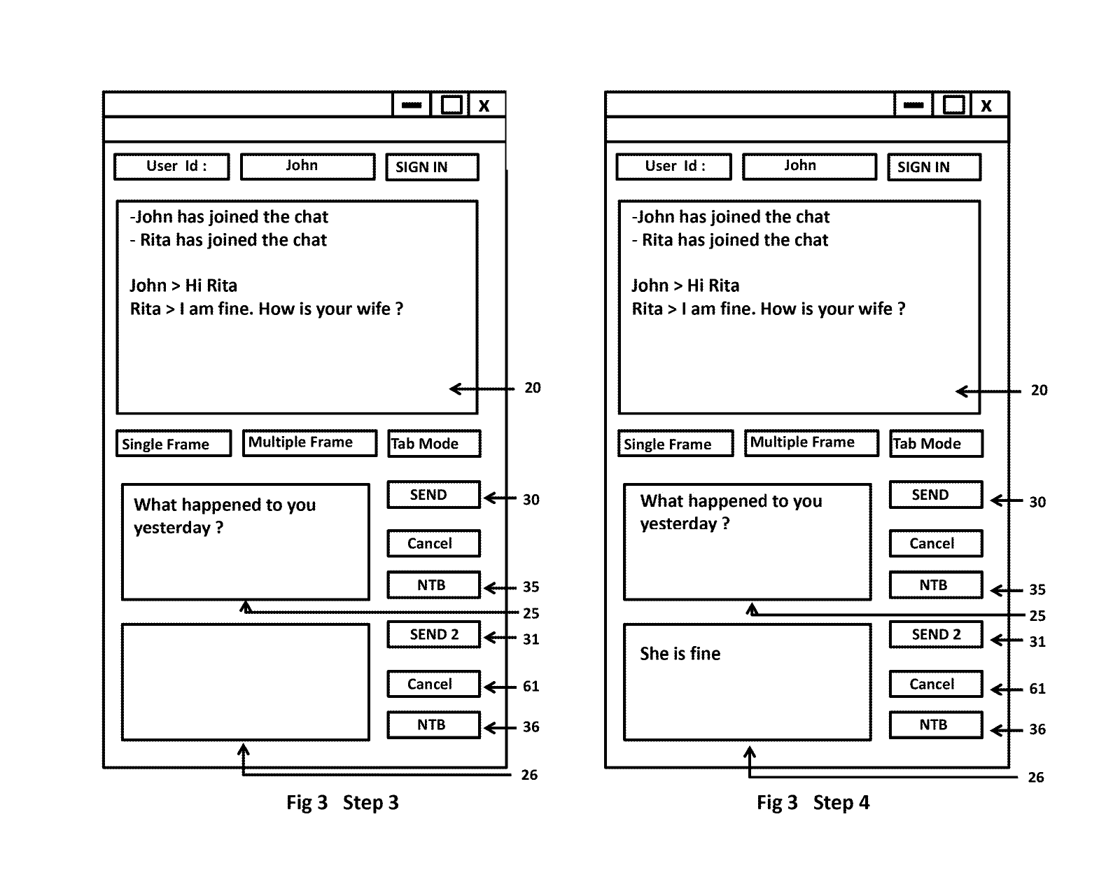

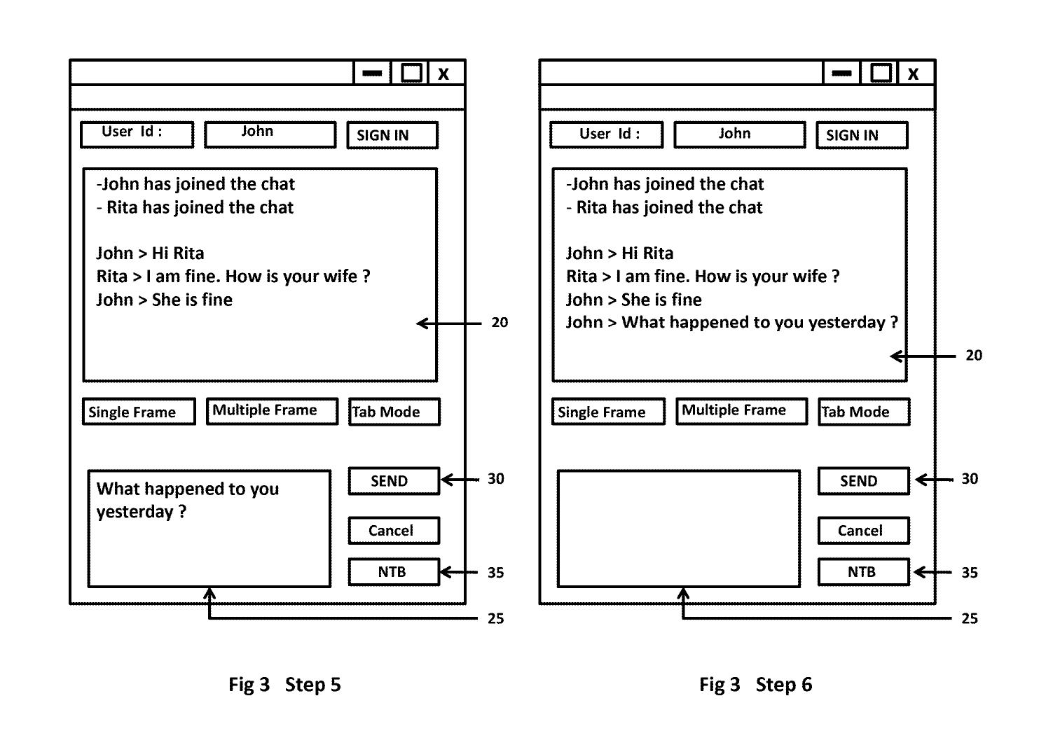

FIG. 3 shows an exemplary step-by-step demonstration of how an exemplary instant messenger client with send sequence control is used in a single frame mode during a chat session between two users, in accordance with an embodiment of the present invention. In the present example, Steps 1 through 6 represent snap shots of a chat discussion between John and Rita, two users in different locations, using instant messenger clients enabled with send sequence control. The drawings show John's instant messenger client, which is in the single frame mode, also shown by way of example in FIGS. 1A and 1C. In Step 1 John logs on to his instant messenger client, and Rita logs on to her instant messenger client. John types his first message into a text input box 25. In Step 2 John clicks a send button 30, and the message is sent to Rita. The sent message now disappears from text input box 25 and appears in a message output area 20. While John waits for Rita to respond, he proceeds to type his next intended message in text input box 25, “What happened to you yesterday?”. However, in Step 3, before John sends this second typed message, Rita sends her response to his first message, which includes the question “How is your wife?”. John prefers to respond to this question before sending his already typed message so as not to disrupt the flow of the conversation, so he clicks an NTB button 35, which creates a new text input box 26 and an associated new send button 31, a new cancel button 61 and a new NTB button 36. In Step 4 John types the more appropriate response into new text input box 26 “She is fine”. John then clicks new send button 31 to send the message to Rita in Step 5. The sent message now appears in message output area 20 as his second sent message while new text input box 26 and the associated new send button 31, new cancel button 61 and new NTB button 36 all disappear. In alternate embodiments the new text input box and its associated control buttons may remain on the screen after a user sends a message from this text input box. In the present embodiment in Step 6, John then clicks send button 30, and his originally typed second message is sent to Rita. This message now appears in message output area 20 as John's third sent message.

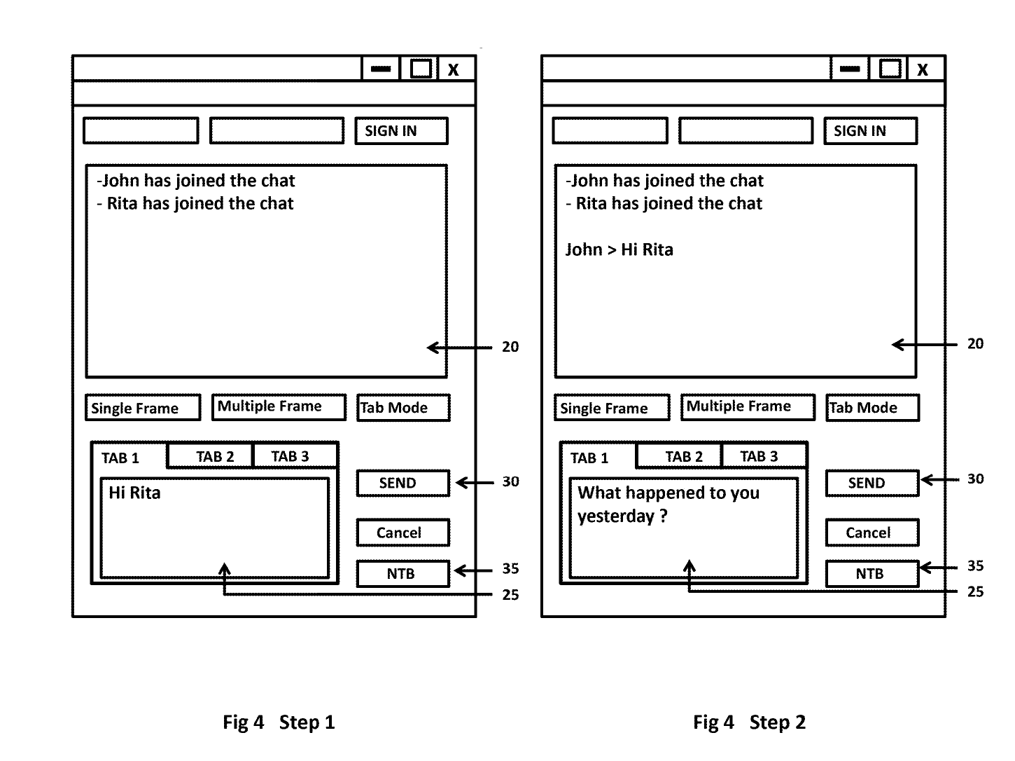

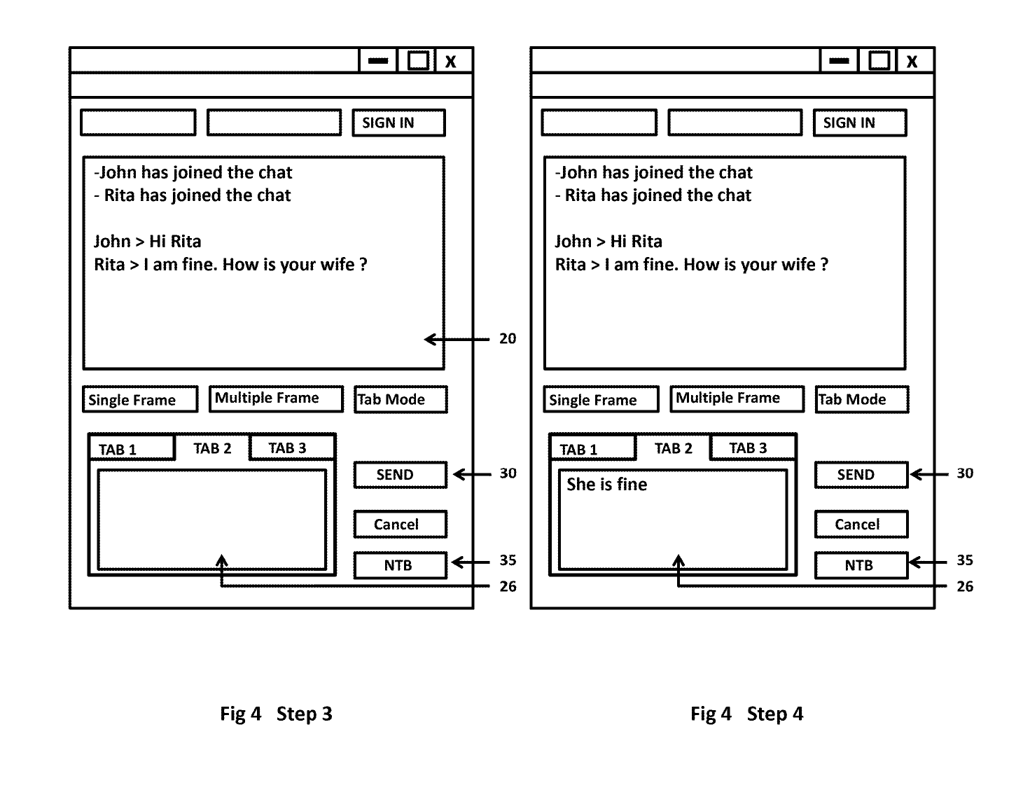

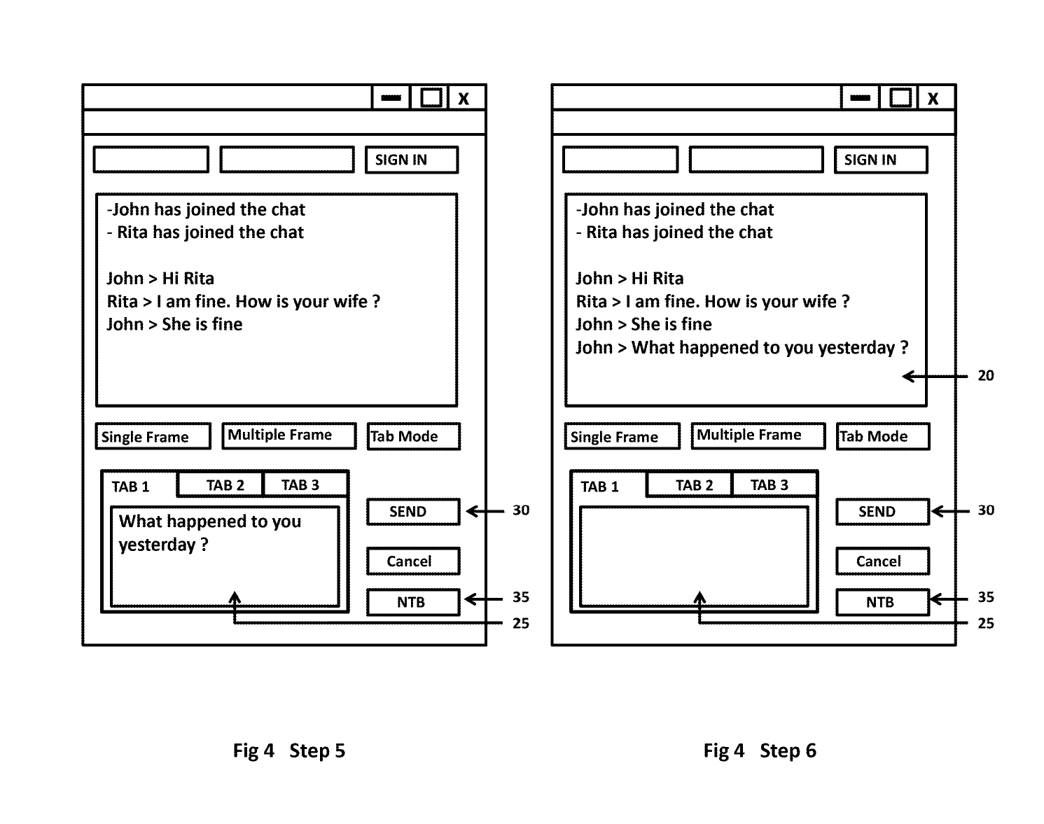

FIG. 4 shows an exemplary step-by-step demonstration of how an exemplary instant messenger client with send sequence control is used in a tab mode during a chat session between two users, in accordance with an embodiment of the present invention. In the present example, Steps 1 through 6 represent snap shots of a chat discussion between John and Rita, two users in different locations, using instant messenger clients enabled with send sequence control. The drawings show John's instant messenger client, which is in the tab mode, also shown by way of example in FIG. 1B. In Step 1 John and Rita log onto their instant messenger clients. John types his first message into a text input box 25 on a TAB 1. In Step 2 John clicks a send button 30, and the message is sent to Rita. The sent message now disappears from the text input box 25 and appears in a message output area 20. While John waits for Rita to respond, he proceeds to type his next intended message, “What happened to you yesterday?”. However, just before John can send this second typed message in Step 3, Rita sends her response, which includes the question “How is your wife?”. John prefers to respond to this question before sending his already typed second message so as not to disrupt the flow of the conversation, so he clicks a TAB 2 which presents him a new text input box 26. In Step 4 John then types the more appropriate response into new text input box 26 “She is fine”. John then clicks send button 30 in Step 5 to send the message to Rita. The sent message now appears in message output area 20 as his second sent message and disappears from new text input box 26. John then clicks TAB 1 and send button 30 so that his originally typed second message is sent to Rita. In Step 6 the sent message now appears in message output area 20 as his third sent message. The chat sessions shown by way of example in FIGS. 3 and 4 are simple two person chats; however, the present embodiment may be used in multiple party chats as in a chat room.

Those skilled in the art, in light of the present teachings, will readily recognize that there are many alternative ways in which preferred embodiments of the present invention may be used or implemented. For example, without limitation, in some embodiments, the buttons may be replaced by any other form of trigger, including, but not limited to, voice triggers. In other alternate embodiments any button could be made to combine its functions with the functions of other buttons. In other alternate embodiments the message to be sent can be highlighted with a mouse or other type of input device and sent via options on the mouse menu instead of by clicking a send button. In these embodiments an entirely new text input box need not be created when separate messages are typed. Instead, a section of the currently available text input box can be highlighted so that the new message can be typed into that section and sent from that section. In yet other alternate embodiments send sequence control may be adapted for voice and/or video communication. In still other alternate embodiments where multiple parties are chatting as in a chat room, multiple TIBs or TABs are automatically opened, one for each of the other persons. In further alternate embodiments with multiple parties, each automatically opened TIB or TAB is labeled with a party's chat name. In yet other embodiments, these labeled TIBs or TABs automatically may automatically insert the associated chat names into the text input boxes awaiting further message input from the user, saving the user time when addressing a message to a specific person. Yet other embodiments may allow a user to save favorite quotes or phrase where these saved quotes or phrases may be inserted into a text input box with a simple key input such as, but not limited to, a keyboard shortcut, function key or other unique key input associated with the saved quote or phrase.

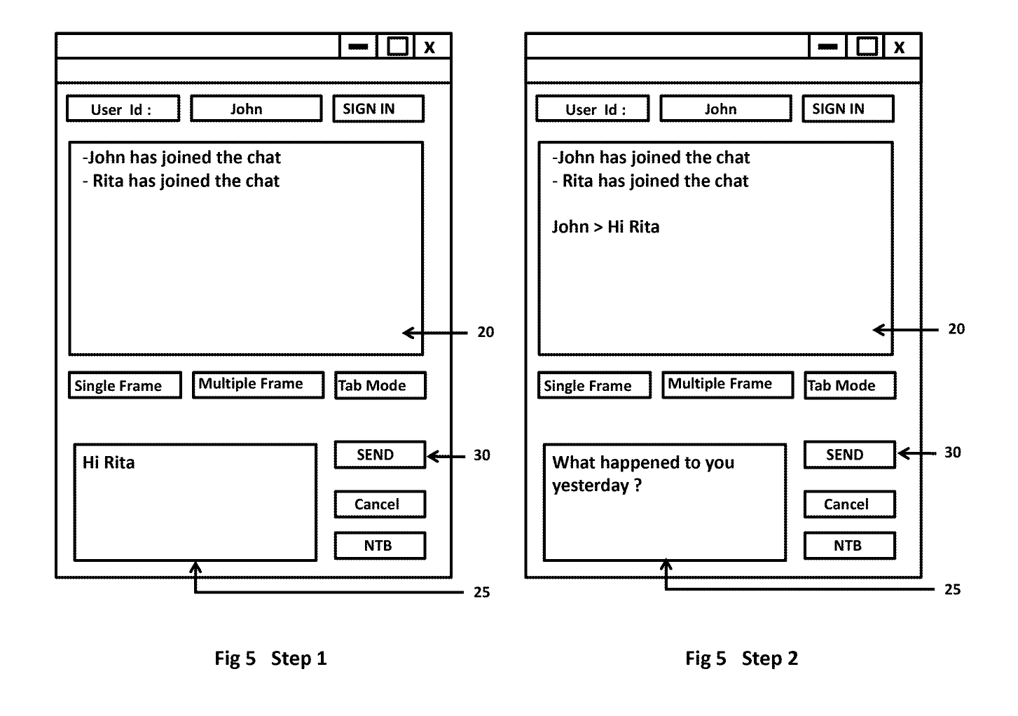

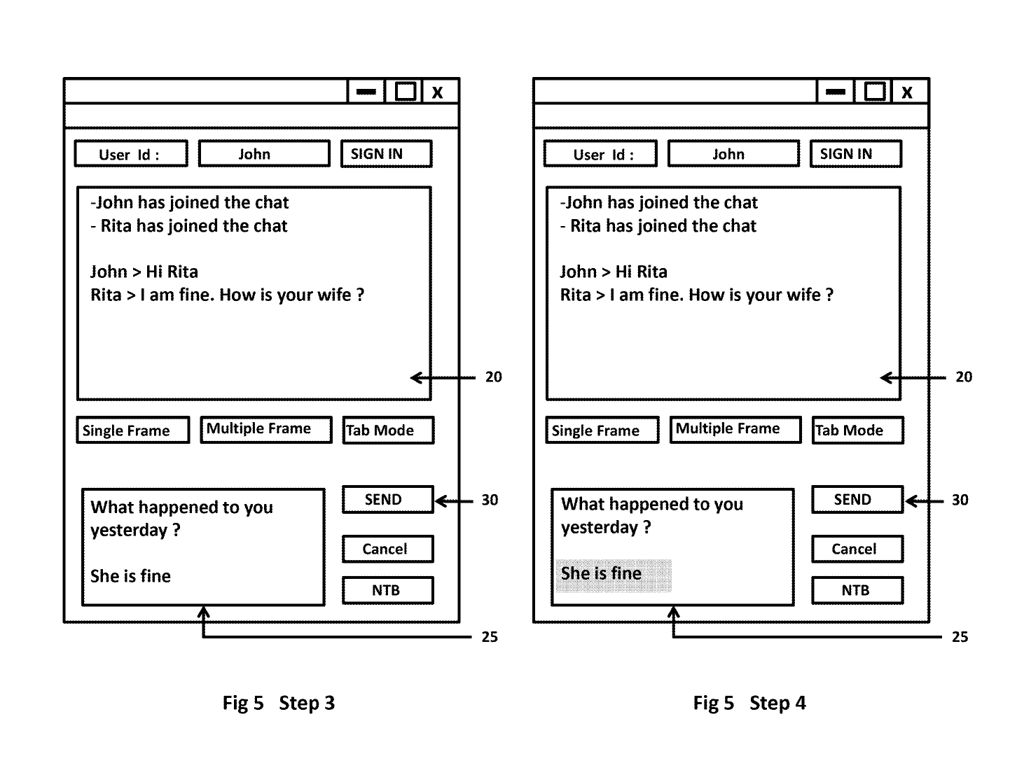

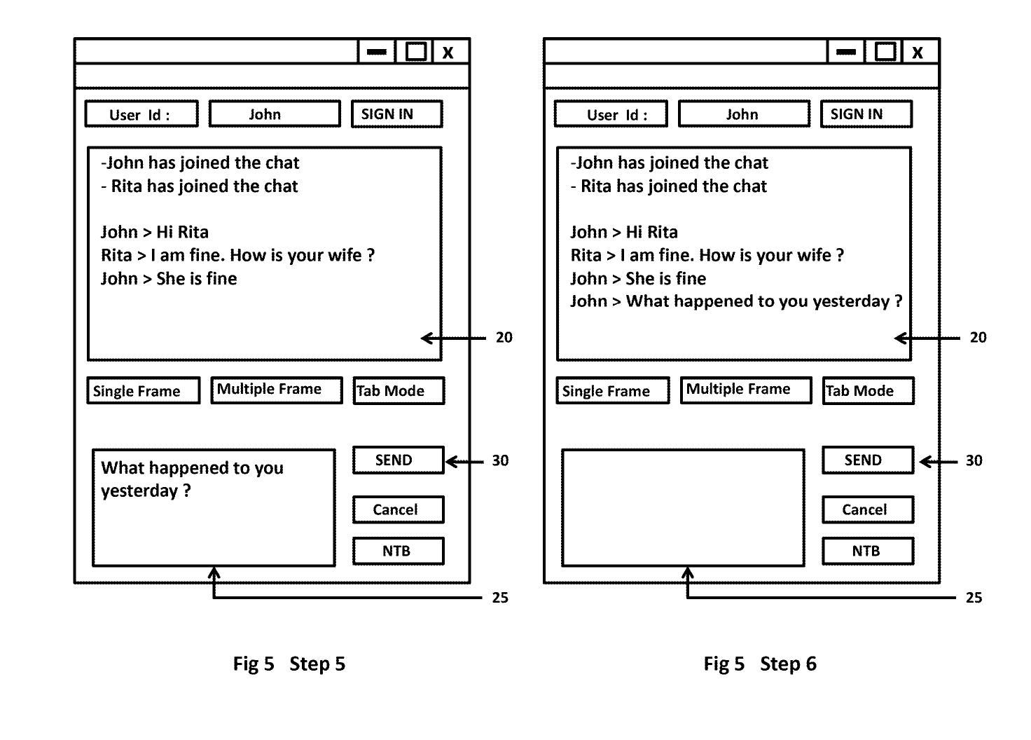

FIG. 5 shows an exemplary step-by-step demonstration of how an exemplary instant messenger client with send sequence control is used in a highlighted mode during a chat session between two users, in accordance with an embodiment of the present invention. In the present example, Steps 1 through 6 represent snap shots of a chat discussion between John and Rita, two users in different locations, using instant messenger clients enabled with send sequence control. The drawings show John's instant messenger client, which is in the single frame mode, also shown by way of example in FIGS. 1A and 1C. In Step 1 John logs on to his instant messenger client, and Rita logs on to her instant messenger client. John types his first message into a text input box 25. In Step 2 John clicks a send button 30, and the message is sent to Rita. The sent message now disappears from text input box 25 and appears in a message output area 20. While John waits for Rita to respond, he proceeds to type his next intended message in text input box 25, “What happened to you yesterday?”. However, in Step 3, before John sends this second typed message, Rita sends her response to his first message, which includes the question “How is your wife?”. John prefers to respond to this question before sending his already typed message so as not to disrupt the flow of the conversation, so he types the more appropriate response into text input box 25 “She is fine”, below the already typed message. In Step 4 John selects the message “She is fine” by highlighting the text using a mouse or other input device. John then accesses a sub menu, such as, but not limited to, a mouse menu, or access a command via a keyboard shortcut, to send the highlighted text message to Rita in Step 5. The sent message now appears in message output area 20 as his second sent message while the highlighted text message disappears. In the present embodiment in Step 6, John then clicks send button 30, and his originally typed second message is sent to Rita. This message now appears in message output area 20 as John's third sent message.

Table 1 is an exemplary Visual Basic program code that may be used to implement single and multiple frame modes of a send sequence enabled instant messenger client, in accordance with an embodiment of the present invention. The codes are for the client and the server with which to test the client. The client code comprises two forms. It should be understood that the exemplary code in the table does not provide a user configuration screen, nor the functionality to highlight and send a portion of typed text, and the button labels are not exactly as labeled in the drawings (yet they serve the same purpose). The exemplary code is rather a simplified/basic exemplary instantiation of a single and multiple frame modes. Those skilled in the art, in light of the present teachings, will readily recognize that the program may be written in a variety of ways, so long as the send sequence control functionality of preferred embodiments of the present invention is achieved.

Those skilled in the art will readily recognize, in accordance with the teachings of the present invention, that any of the foregoing steps and/or system modules may be suitably replaced, reordered, removed and additional steps and/or system modules may be inserted depending upon the needs of the particular application, and that the systems of the foregoing embodiments may be implemented using any of a wide variety of suitable processes and system modules, and is not limited to any particular computer hardware, software, middleware, firmware, microcode and the like. For any method steps described in the present application that can be carried out on a computing machine, a typical computer system can, when appropriately configured or designed, serve as a computer system in which those aspects of the invention may be embodied.

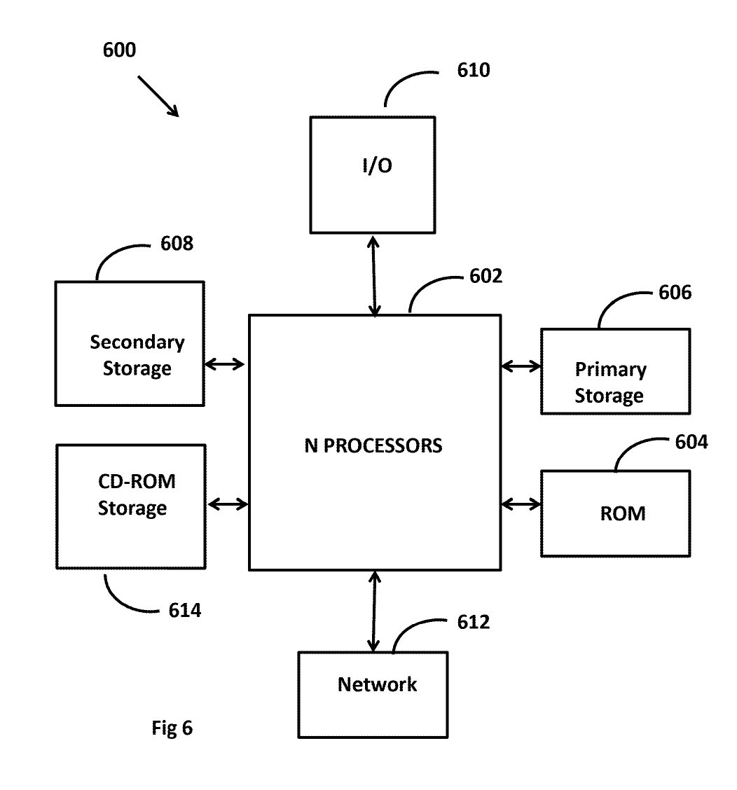

FIG. 6 illustrates a typical computer system that, when appropriately configured or designed, can serve as a computer system in which the invention may be embodied. The computer system 600 includes any number of processors 602 (also referred to as central processing units, or CPUs) that are coupled to storage devices including primary storage 606 (typically a random access memory, or RAM), primary storage 604 (typically a read only memory, or ROM). CPU 602 may be of various types including microcontrollers (e.g., with embedded RAM/ROM) and microprocessors such as programmable devices (e.g., RISC or SISC based, or CPLDs and FPGAs) and unprogrammable devices such as gate array ASICs or general purpose microprocessors. As is well known in the art, primary storage 604 acts to transfer data and instructions uni-directionally to the CPU and primary storage 606 is used typically to transfer data and instructions in a bi-directional manner. Both of these primary storage devices may include any suitable computer-readable media such as those described above. A mass storage device 608 may also be coupled bi-directionally to CPU 602 and provides additional data storage capacity and may include any of the computer-readable media described above. Mass storage device 608 may be used to store programs, data and the like and is typically a secondary storage medium such as a hard disk. It will be appreciated that the information retained within the mass storage device 608, may, in appropriate cases, be incorporated in standard fashion as part of primary storage 606 as virtual memory. A specific mass storage device such as a CD-ROM 614 may also pass data uni-directionally to the CPU.

CPU 602 may also be coupled to an interface 610 that connects to one or more input/output devices such as such as video monitors, track balls, mice, keyboards, microphones, touch-sensitive displays, transducer card readers, magnetic or paper tape readers, tablets, styluses, voice or handwriting recognizers, or other well-known input devices such as, of course, other computers. Finally, CPU 602 optionally may be coupled to an external device such as a database or a computer or telecommunications or internet network using an external connection as shown generally at 612, which may be implemented as a hardwired or wireless communications link using suitable conventional technologies. With such a connection, it is contemplated that the CPU might receive information from the network, or might output information to the network in the course of performing the method steps described in the teachings of the present invention.

It will be further apparent to those skilled in the art that at least a portion of the novel method steps and/or system components of the present invention may be practiced and/or located in location(s) possibly outside the jurisdiction of the United States of America (USA), whereby it will be accordingly readily recognized that at least a subset of the novel method steps and/or system components in the foregoing embodiments must be practiced within the jurisdiction of the USA for the benefit of an entity therein or to achieve an object of the present invention. Thus, some alternate embodiments of the present invention may be configured to comprise a smaller subset of the foregoing novel means for and/or steps described that the applications designer will selectively decide, depending upon the practical considerations of the particular implementation, to carry out and/or locate within the jurisdiction of the USA. For any claims construction of the following claims that are construed under 35 USC §112 (6) it is intended that the corresponding means for and/or steps for carrying out the claimed function also include those embodiments, and equivalents, as contemplated above that implement at least some novel aspects and objects of the present invention in the jurisdiction of the USA. For example, transmission of messages between client messaging programs through a sever may be performed and/or located outside of the jurisdiction of the USA, where the server may reside, while the remaining method steps and/or system components of the forgoing embodiments are typically required to be located/performed in the US for practical considerations.

Having fully described at least one embodiment of the present invention, other equivalent or alternative methods of providing send sequence control functionality according to the present invention will be apparent to those skilled in the art. The invention has been described above by way of illustration, and the specific embodiments disclosed are not intended to limit the invention to the particular forms disclosed. For example, the particular implementation of the send sequence control may vary depending upon the particular type of application used. The applications described in the foregoing were directed to instant messaging implementations; however, similar techniques are to provide send sequence control in other types of applications such as, but not limited to, social networking sites, search engines, databases, etc. Non-instant messaging implementations of the present invention are contemplated as within the scope of the present invention. The invention is thus to cover all modifications, equivalents, and alternatives falling within the spirit and scope of the following claims.

Claim elements and steps herein have been numbered and/or lettered solely as an aid in readability and understanding. As such, the numbering and lettering in itself is not intended to and should not be taken to indicate the ordering of elements and/or steps in the claims.

What is claimed is:

1. A method comprising:
steps for engaging in a messaging conversation over a communication network;
steps for preparing messages using a plurality of text input boxes; and
steps for selecting a text input box for sending a contained message.

2. The method as recited in claim 1, further comprising steps for sending at least a portion of said contained message separately from said contained message.

3. The method as recited in claim 1, further comprising steps for adding an additional text input box.

4. The method as recited in claim 1, further comprising steps for canceling a text input box.

5. A method comprising the steps of:
engaging in a messaging conversation with at least one party over a communication network;
preparing messages for said at least one party using a plurality of text input boxes; and
selecting a one of said plurality of text input boxes for sending to said at least one party a contained message within said one of said plurality of text input boxes.

6. The method as recited in claim 5, further comprising highlighting at least a portion of said contained message for sending said highlighted portion separately from said contained message.

7. The method as recited in claim 5, further comprising the step of adding an additional text input box to said plurality of text input boxes.

8. The method as recited in claim 5, further comprising the step of canceling a text input box wherein said contained message is deleted.

9. The method as recited in claim 8, wherein said text input box is removed from view.

10. The method as recited in claim 5, wherein each of said plurality of text input boxes is tabbed for selecting for input and for sending.

11. The method as recited in claim 5, wherein said text input boxes are contained in a plurality of frames.

12. A system comprising:
means for logging on to engage in a messaging conversation with at least one party over a communication network;
means for preparing messages for said at least one party using a plurality of text input boxes; and
means for selecting a one of said plurality of text input boxes for sending to said at least one party a contained message within said one of said plurality of text input boxes.

13. The system as recited in claim 12, further comprising means for sending at least a portion of said contained message separately from said contained message.

14. The system as recited in claim 12, further comprising means for adding an additional text input box.

15. The system as recited in claim 12, further comprising means for canceling a text input box.

16. A computer program product residing on or being distributed across one or more computer readable mediums having a plurality of instructions stored thereon which, when executed by one or more associated processors, cause the one or more processors to:
enable a user to engage in a messaging conversation with at least one party over a communication network;
enable a user to prepare messages for said at least one party using a plurality of text input boxes; and
enable a user to select a one of said plurality of text input boxes for sending to said at least one party a contained message within said one of said plurality of text input boxes.

17. The computer program product as recited in claim 16, further comprising instructions to enable a user to highlight at least a portion of said contained message for sending said highlighted portion separately from said contained message.

18. The computer program product as recited in claim 16, further comprising instructions to enable a user to add an additional text input box to said plurality of text input boxes.

19. The computer program product as recited in claim 16, further comprising instructions to enable a user to cancel a text input box wherein said contained message is deleted.

20. The computer program product as recited in claim 19, wherein said text input box is removed from view.

21. The computer program product as recited in claim 16, wherein each of said plurality of text input boxes is tabbed for selecting for input and for sending.

22. The computer program product as recited in claim 16, wherein said text input boxes are contained in a plurality of frames.
